(19) United States
(12) Patent Application Publication
(10) Pub. No.: US 2021/0316855 A1
(43) Pub. Date: Oct. 14, 2021

(54) AIR-GROUND OPERABLE POWERED ULTRALIGHT VEHICLE

(71) Applicant: Sean Sherman, METAIRIE, LA (US)

(72) Inventor: Sean Sherman, METAIRIE, LA (US)

(21) Appl. No.: 16/846,390

(22) Filed: Apr. 12, 2020

(51) Int. Cl. B64C 37/00; B64C 31/036

(52) U.S. Cl. CPC B64C 37/00; B64C 31/036

(57) ABSTRACT

A dual air-ground operable powered ultralight vehicle comprises a frame and a power apparatus applying power to the propeller and a ground traction element. Attached to the frame is a flexible wing that may allow the vehicle to become airborne when power is applied to the propeller. The wing would be detachable from the frame to allow for ground operations. A power transfer device shifts power of the power apparatus to either the propeller or the ground traction element. The vehicle will fall into the Federal Aviation Authority's Federal Aviation Regulation Part 103, Ultralight Vehicle.

### FIELD OF INVENTION

The invention disclosed herein pertains generally to the field of both flying vehicles and drivable ground vehicles. Specifically, vehicles that are capable of performing both powered flight and ground operations, while conforming to the definition of powered ultralight vehicle as set forth by the Federal Aviation Administration (FAA) Federal Aviation Regulation (FAR) Part 103.

### BACKGROUND OF THE INVENTION

Stories of personal flying ground vehicles fill human imagination, but rarely do these fantasies become a serious reality. Innumerable factors crop up with regards to the technical and legal feasibility to produce such vehicles. When these factors are overcome, it is typically done in a fashion that leaves much to be desired by the intended user. Furthermore, many regulations artificially restrict the capability of such vehicles in technical and legal use. An Air-Ground operable vehicle must obviously be capable of powered and controlled movement through both the air while flying, and on the ground while driving.

Engineering a flying ground vehicle itself is a herculean task. But to design one that the majority of people can legally use without additional training has been a dream out of reach. All currently available flying ground vehicles require many hours of instruction before the user can be licensed, often resulting in costs of thousands of dollars. To date, no viable air-ground vehicle has been designed to allow a user without an aviation license to operate it.

U.S. Patent Pub. No 2007/0023566 A1 by Howard describes a “Flying All-Terrain vehicle” which is capable is powered flight and ground driving. This patent specifically states that the vehicle is intended to be flown by pilots with an FAA “Sport Aviation rating”. Such a rating would explicitly prohibit people without a sport pilot license or above from flying this vehicle.

U.S. Pat. No. 9,884,530 B2 by Hamel describes a vehicle nearly identical to the one put forth by Howard. This patent describes a vehicle that has “a dry weight between 1,000 lbs and 1,450 lbs”. Such intended weight would put a flying vehicle of this type immediately into the FAA's sport aviation category, if not into the general aviation category.

U.S. Pat. No. 9,682,620 B2 by Nolan describes another similar vehicle, which integrates the fuel tank into the vehicle's structural members. It is obvious to anyone having ordinary skill in this art that this vehicle obviously does not fit into the FAA's Ultralight Vehicle category, as it obviously grosses over 254 lbs dry weight. Further, Nolan's description of the vehicle states that the propeller serves as the primary method of locomotion for both flight in the air and movement across the ground. Using the propeller for ground movement, while simple, is very inefficient.

Although these devices are similar, they all lack a solution to the problem of allowing any lay person to operate the vehicle. All of these vehicles fall into at least the sport aviation category because of weight restrictions, and none of the designs attempt to solve this problem.

What is needed in this art is a vehicle that is powered and controllable while flying through the air, and while driving on the ground, and which also meets the regulations of the governing federal authorities on aviation, that any lay-person may operate it without the need for additional licensing. In short, a ultralight aircraft ground vehicle.

### SUMMARY OF THE INVENTION

It is one objective of the present invention to function as a dual air-ground operable ultralight vehicle that falls within the FAA's Ultralight Vehicle category.

In some forms of the invention, the vehicle is capable of controlled powered operation on the ground or controlled powered flight in the air. This vehicle would be capable of taking off and landing under its own power.

In some forms of the invention, the wing structure may be a ram-air parafoil technology. The surface area of the ram-air parafoil is preferably between 260 square feet to 500 square feet.

In some forms of the invention, there may be two wheels at the front of the vehicle for steering the vehicle on the ground.

In some forms of the invention, the vehicle may be completely powered by a single power apparatus. This would be advantageous, as the use of a single power apparatus would greatly reduce the weight of the vehicle.

In some forms of the invention, when the vehicle is powered by a single power apparatus, a device will exist that will shift power to either the wheels or the propeller. This device could be mechanical. This device could be shifted by hand with mechanical linkage. In this embodiment, the power apparatus could be attached to the wheels or propeller mechanically. This device would ensure that the wheels and the propeller could not be operated simultaneously.

In some forms of the invention, the power apparatus would be an internal combustion engine. This engine would preferably be greater than 20 horsepower, and less than 60 pounds, so as to produce the highest power-to-weight ratio possible. Preferably this engine would have a power to weight ratio of at least 0.6 hp/lb. Other means of powering the vehicle could be electric motors as long as care is taken to ensure that power and weight restrictions are met.

In some forms of the invention, there exists a clutch attached to the power apparatus to allow for the engine to operate at efficient speed while allowing the ground wheels to be fully arrested in movement. This would reduce the stress on the power apparatus while also allowing for easier operation of the vehicle for ground operations.

In some forms of the invention, there may be two wheels at the rear of the vehicle for powering the vehicle on the ground. The rear wheels would be connected to the power apparatus via a mechanism to allow power to be directed from the power apparatus to the wheels.

In some forms of the invention, there is a right-angle gearbox connecting the propeller to the power apparatus. Power is transferred through the clutch and the power shifting device to the right-angle gearbox to spin the propeller.

In some forms of the invention, the primary mode of flight is propelled by a single propeller attached to the power apparatus. This propeller is attached to the rear of the frame of the vehicle so that when it is powered it produces thrust to the rear, propelling the vehicle forward. The propeller is preferably between 46 inches to 64 inches in diameter.

In some forms of the invention, the propeller may be protected by a propeller shroud. This shroud could partially surround the propeller as to protect the propeller from parachute lines, but not to cause an impedance during ground travel. This shroud would be constructed of similar materials as the frame, but preferably of a smaller tube diameter so as to reduce weight. This propeller shroud may be removable so as to allow for easier storage of the vehicle.

In some forms of the invention, the frame could be steel or aluminum to satisfy the FAA's requirements for ultralight vehicles, being under 254 pounds weight. The frame members would preferably be tubular in cross-section to provide structural integrity. Steel framed members would preferably use 41xx series of steels. Aluminum frames would preferably use 60xx series of aluminums. Frames would preferably use bent and welded frame members for construction of the frame.

In some forms of the invention, the vehicle may have suspension mechanisms for the front and/or rear wheels, to support operations while driving on the ground. Preferably the front wheels would use a spring coil assembled into the steering spindle. The rear wheels would preferably use single swing arm suspension with a coilover or pneumatic shock. These suspensions sacrifice the superior suspension characteristics of more traditional methods of suspension (such as double A-arm) for being lighter in weight enabling the vehicle to be kept under 254 pounds weight.

In some forms of the invention, there may be a dashboard/avionics suite attached near the front of the vehicle to give the driver/pilot more situational awareness.

In some forms of the invention, there are two foot operated pedals; a throttle pedal to control the power of the power apparatus, and a brake pedal to apply braking power to the driven rear wheels. The throttle pedal attaches to the power apparatus via a wire cable.

In some forms of the invention, an additional device to steer the front wheel(s) while on the ground with a foot is attached, as to allow the operator to control the wing with their hands, and to control the steering of the wheel(s) with their foot. This device would be operated with the foot that does not operate the throttle pedal.

In some forms of the invention, the wing is controlled with the feet via extensions of the controls, or addition of another support mechanism, so as to allow the operator to steer the front wheel(s) with their hands.

In some forms of the invention, there is an additional throttle control that is operated with the use of a single hand, while not severely limiting that hand.

Further objectives and advantages of the invention will become apparent from a consideration of the drawings and ensuing description.

### BRIEF DESCRIPTION OF THE DRAWINGS

Figure (FIG. 1 is a perspective view of a first exemplary embodiment of the ultralight air-ground vehicle from the front right side.

FIG. 2 is an exemplary embodiment from the rear right side of the vehicle.

FIG. 3 is an exemplary embodiment of the vehicle as configured for flight, from the from right side.

FIG. 4 depicts a close up and more detailed view of the right side of the vehicle as configured for flight.

FIG. 5 depicts a close up and more detailed view of the rear of the vehicle. This view specifically points out various parts of the apparatus powering the movement of the vehicle.

FIG. 6 is a block diagram illustrating the connections of the power train.

### DETAILED DESCRIPTION OF THE INVENTION

The invention described herein will be understood by reference to the following detailed description. This description is meant to be aided be and read in conjunction with the related drawings. It is expected that the following detailed description of assorted embodiments is to make an example of only and is not meant to be limiting the scope of the present invention. The inventor anticipates that such variations may include utilizing some or all of various aspects of the present invention, stating alone, or in combinations other than expressly disclosed herein with respect to the preferred embodiments. Accordingly, this invention includes all modifications and equivalents of the subject matter recited or suggested herein as permitted by applicable law. Moreover, any combination of the above-described elements in all possible variations thereof is encompassed by the invention unless otherwise indicated herein or otherwise clearly contradicted by context.

The terms “a” and “an” and “the” and similar referents in describing the invention are to be interpreted to cover both singular and plural forms, unless otherwise indicated or contraindicated by the context. The terms “having,” “including,” and “containing,” are to be interpreted as open-ended terms (i.e., “including, but not limited to.”) unless otherwise noted.

The use of any and all examples, or exemplary language (e.g., “Such as”) provided is intended merely to better illuminate the invention and does not pose a limitation on the scope of the invention unless otherwise claimed. It is also to be understood that the terminology used is used to describe certain embodiments only, and is not intended to limit the scope of the invention.

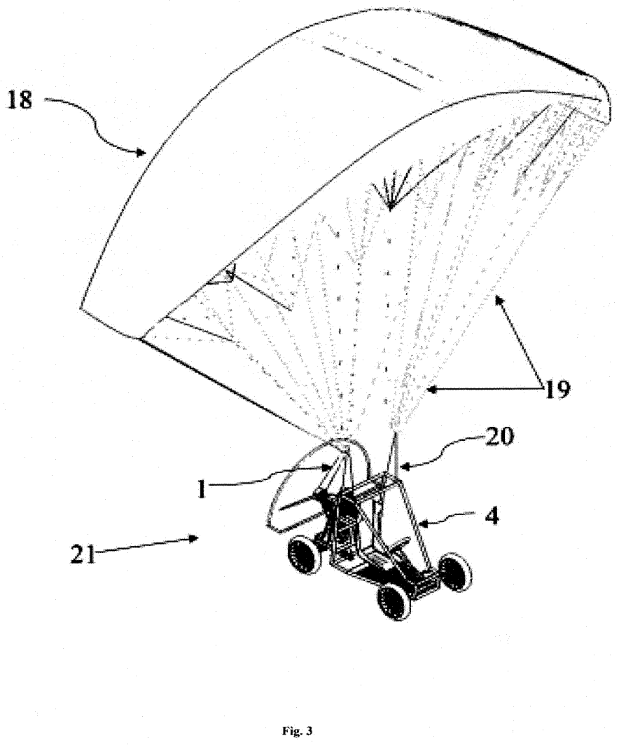

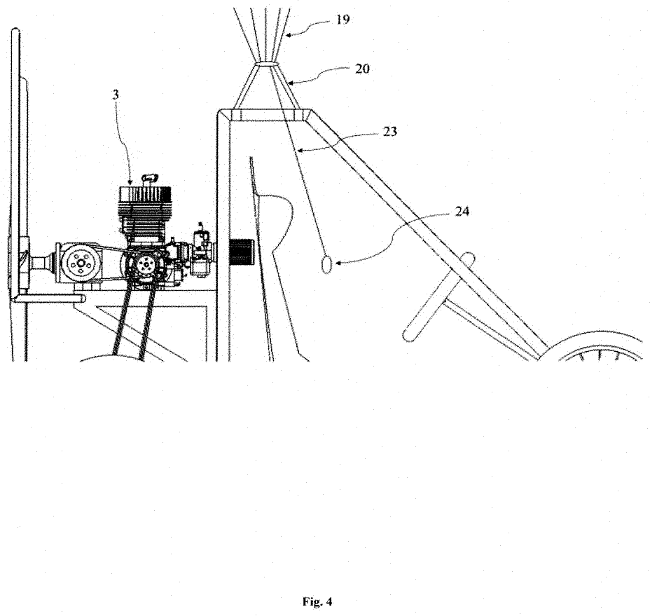

FIGS. 1-5 show exemplary embodiments of a vehicle 21, according to the invention, in the form of an ultralight air-ground vehicle, which is configured for controlled powered operation both on the ground (FIG. 1) and in the air (FIG. 3)

FIG. 1 shows an assembled vehicle 21 for ground operation. Shown is the frame 4 to which is attached the engine 3, the ground steering mechanism 6, the front wheels 8, the pedals 9, and the operator's seat 7. The engine 3 delivers power to the propeller 1 or separately to the rear wheels 22.

The engine 3 is preferably an internal combustion engine, having at least 20 horsepower, and weighing no more than 60 pounds. Ideally, the engine would have a power-to-weight ratio greater than 0.6 hp/lb. The engine 3 would ideally be air aspirated. Preferably 2-stroke over 4-stroke engines would be used to ensure proper weight restrictions. 4-stroke engines could be used provided that the vehicle weight requirement of less than 254 pounds and power requirement of enabling flight under a ram-air style parafoil were met.

The frame 4 should be constructed of a material that will be light enough that the entire vehicle 21 will meet the FAA's standards for ultralight vehicles. The frame 4 shown here is constructed of a tubular 41xx steel. Tube frame members are preferably cut and bent to required shapes and then welded together. The frame 4 is constructed in a manner so as to provide protection as a roll cage for the operator seated in the seat 7.

To conform with regulations for ultralight aircraft, there is only one seat 7 available for one operator of the vehicle.

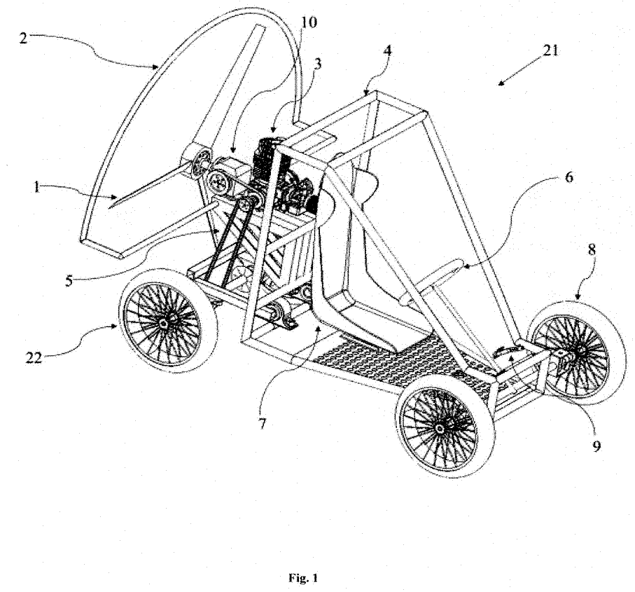

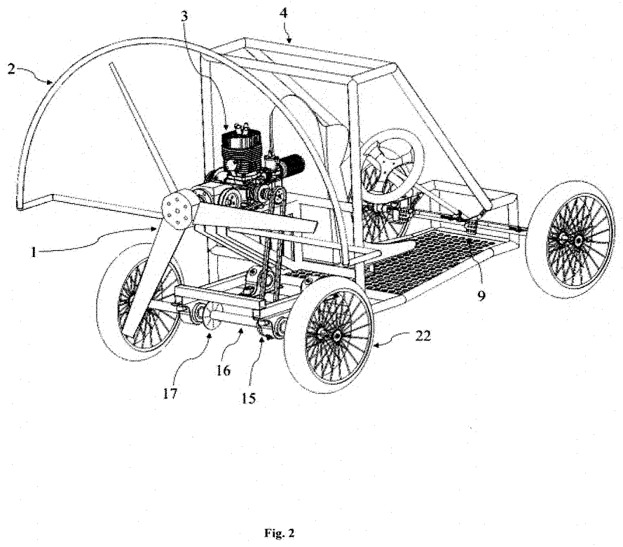

FIG. 2 shows a pedal 9 (typically the throttle) and a rear axle brake 17. In this embodiment, the pedals 9 would operate the throttle of the engine 3 and apply pressure to the rear axle brake 17. Other embodiments could have a different set of controls for the throttle and brake, such as those operated by hand on some aircraft.

FIG. 2 shows engine 3 powering the propeller 1 via a belt 12. This belt is attached to a right-angle gear box 10 via a pulley 11. In other embodiments, this power transfer could be make using a chain driving sprocket gears as well.

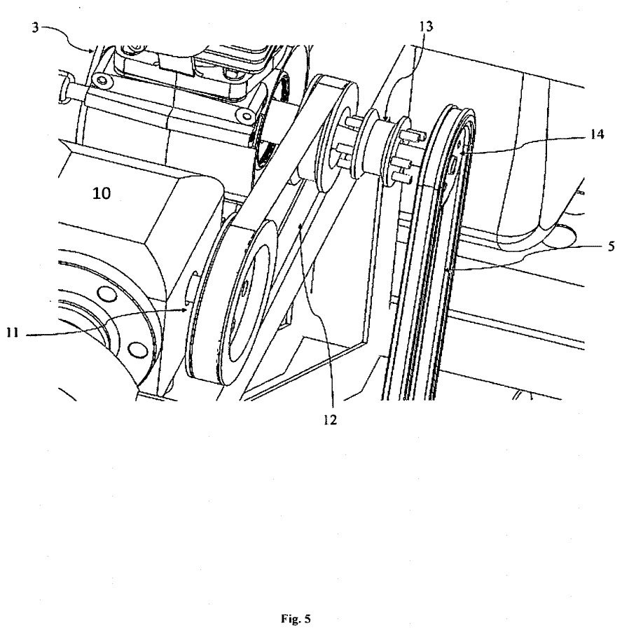

FIGS. 2 and 5 show engine 3 powering the rear axle 16 via a roller chain 5 connected to an idle sprocket 15 on the rear axle 16 and the engine 3. In this embodiment the idle sprocket 15 is engaged to the engine 3 power via a power transfer device (shifter) 13 that would transfer power to either the belt 12 for the propeller 1, or to the chain 5 for the rear axle.

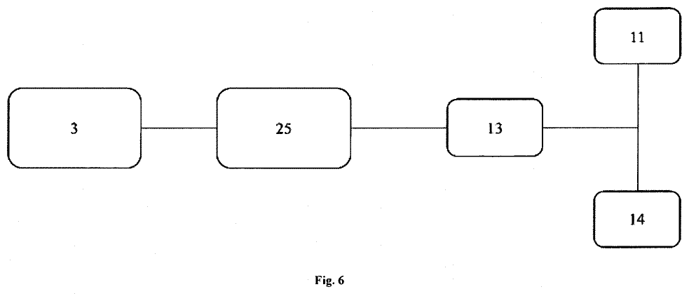

FIG. 6 illustrates the connections of the power train. The power transfer device/shifter lies on the same shaft as the clutch 25. The shifter 13 is moved to engage either the propeller belt system 11 or the ground drive chain system 14. The clutch 25 does not engage until the engine 3 has reached a rotational speed at or above a desired threshold, typically around 1000 rpm. Once the clutch 25 engages the shifter 13, the shifter transfers the power to either the propeller belt system 11 or the ground drive chain system 14. The shifter may also not be engaged to either system. In this position the shifter would be in neutral, not providing power to anything. The belt system 12 and the ground drive chain system 14 are mounted on idler bearings so that power from the clutch 25 is not transferred to them. This ensures that the only possible way for the propeller 1 or the rear wheels 22 to receive power is for the power transfer device 13 to be engaged properly.

A right-angle gear box 10 is mounted between the propeller 1 and the propeller belt system 11. This serves to translate the mechanical motion of the engine into useful work done by the propeller. In this way, no right-angle gear box is necessary to transfer power to the rear axle 16 for ground locomotion, as this axle is parallel to the output shaft of the engine 3. The right-angle gear box 10 is preferably mounted 1 inch to 6 inches rearward of the engine 3.

FIG. 3 depicts the rear wheels 22 connected to the rear axle 16 and mounted to the frame in a swing arm type suspension. The swing arm type suspension would preferably have a maximum travel distance of 5 inches.

The wheels 8 and 22 depicted in these embodiments do not necessarily have to be wheels. In some embodiments, particularly for winter activities, embodiments could replace the front wheels with skis, and the rear wheels with tracks, so that traveling over snow may be easier.

FIG. 1 shows the front wheels 8 attached to the ground steering mechanism 6 via a rack and pinion steering system. Other ground steering mechanisms could include using the feet, so as to free the hands to operate the flying wing.

The front wheels 8 use a spring coil assembled into the wheel spindles to provide suspension for the front end of the vehicle 21. Maximum travel of the front wheels would not be more than 2 inches.

The base of the frame should preferably be raised between 5 inches to 12 inches off of the ground so that small obstacles may be cleared without difficulty while traversing the ground.

The wheelbase (distance between the front wheel axle and the rear wheel axle) would preferably be approximately 72 inches. The front track and rear track widths should be similar to each other, but do not have to be identical. Rear track width would preferably be between 30 inches to 40 inches, while the front track width would preferably be between 25 and 35 inches. Maintaining a ratio of approximately 2:1 wheelbase to track width is preferable so that the vehicle retains proper handling characteristics while traversing on the ground.

FIG. 3 shows the vehicle 21 in flight. The ram-air parafoil 18 is seen above and attached to the vehicle 21 below by parafoil lines 19 and the risers 20. Along these parafoil lines 19 run the control lines 23 for controlling the flight of the vehicle 21.

In this embodiment, the control lines 23 are held with, and controlled by, the operator's hands using steering toggles 24; the left control line running to the operator's left hand, and the right control line running to the operator's right hand Other embodiments could have these control lines 23 attached to a separate duplicate set of pedals 9 worked by the operator's feet to control the flight of the vehicle. The control lines 23 work as they do on any regular parafoil while in flight; pulling on the right control line puts the vehicle 21 into a right hand turn and pulling the left control line puts the vehicle into a left hand turn.

The ram-air parafoil 18 is attached to the vehicle frame 4 via the parafoil lines 19 and the risers 20. In some embodiments there may be brackets or outriggers of sorts attached to the top of the frame 4 for the risers 20 to attach to.

The propeller 1 in this embodiment has 3 blades, but other embodiments of the invention may have fewer or greater than 3 blades on the propeller. Ideally the vehicle 21 would use a propeller 46 inches to 64 inches in diameter.

The propeller shroud 2 is seen to have a semi-circular design, so as to enable more ground clearance during powered ground travel. One skilled in the art to practice the embodiments of the invention could foresee opportunities to modify the shape and size of the propeller shroud for varying purposes. The shroud 2 covers the top half of the propeller 1 to shield it from the parafoil lines 19, especially when taking off and landing.

A propeller shroud 2 is attached to the rear of the frame 4 for directing the parafoil lines 19 and the ram-air parafoil 18 away from the propeller 1. The propeller shroud 2 could be attached in such a way to the frame 4 so as to be completely removed when the vehicle 21 is configured only for ground operation or for storage. The shroud 2 should have a diameter in a range of 1 to 3 inches larger than the propeller 1 diameter. The plane of the propeller shroud should preferably be parallel to the plane of the propeller.

Having described the preferred embodiment, it will become apparent that various modifications can be made without departing from the scope of the invention as defined in this document.

What is claimed is:

1. An ultralight aircraft ground vehicle capable of both powered flight and powered ground locomotion comprising:
a single power apparatus/engine supplying power to both the propeller and the ground wheels separately
a method of switching power from the power apparatus to either the propeller or the ground wheels
a frame
a ram-air style parafoil operatively attached to the frame for flight of the vehicle and for control of the vehicle in the air
an assembled weight of not more than 254 pounds.

2. The ultralight aircraft ground vehicle of claim 1 wherein the combined weight of the entire assembled vehicle does not weigh more than 254 lbs.

3. The ultralight aircraft ground vehicle of claim 1 wherein the ram-air style parafoil provides both flight and airborne control of the vehicle.

4. The ultralight aircraft ground vehicle of claim 1 wherein the steering lines from the ram-air style parafoil are manipulated by hand by the operator in the vehicle.

5. The ultralight aircraft ground vehicle of claim 3 wherein the surface area of the ram-air style parafoil is preferably between 260 square feet to 500 square feet

6. The ultralight aircraft ground vehicle of claim 1 wherein a clutch is attached to the engine to reduce stress on the engine.

7. The ultralight aircraft ground vehicle of claim 6 wherein the clutch operates to ensure that the engine is operating while the ground wheels are not in motion, engaging at a desirable speed so that engine power can be delivered without damaging the engine.

8. The ultralight aircraft ground vehicle of claim 6 where the clutch is mechanically assembled and attached to the engine so that the centrifugal force will engage the clutch at the desired engine rotational speed.

9. The ultralight aircraft ground vehicle of claim 1 wherein a power transfer device exists that transfers the engine power between either the ground wheels or the propeller, but not both at the same time.

10. The ultralight aircraft ground vehicle of claim 9 wherein the power transfer device is manually manipulated by the operator to engage either the propeller or the ground wheels.

11. The ultralight aircraft ground vehicle of claim 9 wherein the power transfer device engages a series of gears to provide a correct engine speed to propeller speed ratio when the power transfer device is engaged to power the propeller.

12. The ultralight aircraft ground vehicle of claim 10 wherein the power transfer device engages a separate series of gears to provide a correct engine speed to ground wheel speed ratio when the power transfer device is engaged to power the ground wheels.

13. The ultralight aircraft ground vehicle of claim 9 wherein the power transfer device has the option for neutral, meaning that neither the propeller nor the ground wheels are provided power from the engine.

14. The ultralight aircraft ground vehicle of claim 1 wherein the engine provides at least 20 horsepower.

15. The ultralight aircraft ground vehicle of claim 1 wherein a fuel tank exists of which the volume does not exceed 5 gallons.

16. The ultralight aircraft ground vehicle of claim 1 wherein one seat is attached to the vehicle to allow for a single occupant to use the vehicle.

17. The ultralight aircraft ground vehicle of claim 1 wherein the vehicle has a propeller shroud that can be optionally detached from the vehicle.

18. The ultralight aircraft ground vehicle of claim 1 wherein the foot operated pedals attached to the vehicle separately operate a brake for the ground wheels, and the throttle for the engine.

19. The ultralight aircraft ground vehicle of claim 1 wherein a right-angle gearbox serves as a connection between the propeller and the engine.
